(19) United States
(12) Patent Application Publication
(10) Pub. No.: US 2026/0109278 A1
(43) Pub. Date: Apr. 23, 2026

(54) UPHOLSTERY PIECE FOR MOTOR VEHICLE

(71) Applicant: GRAMMER AG, Ursensollen (DE)

(72) Inventor: Steve Kober, Treuen (DE)

(21) Appl. No.: 19/308,202

(22) Filed: Aug. 23, 2025

(30) Foreign Application Priority Data
Sep. 17, 2024 (DE) 10 2024 126 720.8

(51) Int. Cl. B60N 2/58; B60N 2/80

(52) U.S. Cl. CPC B60N 2/5816; B60N 2/5891; B60N 2/80

(57) ABSTRACT

An upholstery piece of a motor vehicle, the upholstery piece including a chassis; a cushion arranged at the chassis; a textile cover at least partially covering and/or enveloping the cushion and including an attachment contour; and an attachment bar arranged at the textile cover and fixable at the chassis by the attachment contour, wherein the textile cover includes a thermoplastic material made from thermoplastic synthetic fibers, and wherein the thermoplastic material of the textile cover is compressed to form the attachment bar.

### RELATED APPLICATIONS

This application claims priority from and incorporates by reference German patent application 10 2024 126 720.8, filed on Sep. 17, 2024.

### FIELD OF THE INVENTION

The invention relates to an upholstery piece for a motor vehicle.

### BACKGROUND OF THE INVENTION

Motor vehicle upholstery pieces are well known in the art. Typical upholstery pieces are head rests, arm rests, passenger seats, or components thereof.

All these upholstery pieces include a chassis, including a cushion arranged thereon. The cushion can simply rest on the chassis or can be attached at the chassis by suitable devices. Typically, the cushions are foam materials or other reset elastic materials that are comfortable for a user and suitable for an application. Cushions for head rests do not only provide user comfort, but they also provide sufficient shock absorption in case of the motor vehicle being involved in an accident.

The cushions are typically provided with a cover at least in a visible area. This cover is typically made from a textile material and is designated as a textile cover in the instant application.

The textile cover has to be attached in order not to come loose from the cushion. Typically, the attachment is provided by suitable attachment elements, in particular, by one or more attachment bars that are attached at the textile cover, typically sewn on. These attachment bars engage suitable attachment contours of the chassis.

In case of head rests, the cushion is typically indirectly attached at the chassis by the cover and typically does not include attachment devices itself.

Manufacturers are encouraged to improve the ability to recycle their products due to environmental protection reasons and in order to save resources.

Easy recycling can be provided by making different materials of a product easily separable and/or sortable, so that they can be fed into recycling cleanly sorted. The effort required for product recycling can be additionally reduced by using fewer different materials in a product. Using fewer different materials for producing a product causes less disassembly and sorting complexity.

### BRIEF SUMMARY OF THE INVENTION

Thus, it is an object of the invention to improve recyclability of upholstery pieces of motor vehicles.

The object is achieved by an upholstery piece of a motor vehicle, the upholstery piece including a chassis; a cushion arranged at the chassis; a textile cover at least partially covering and/or enveloping the cushion and including an attachment contour; and an attachment bar arranged at the textile cover and fixable at the chassis by the attachment contour, wherein the textile cover includes a thermoplastic material made from thermoplastic synthetic fibers, and wherein the thermoplastic material of the textile cover is compressed to form the attachment bar.

When using a textile cover that includes thermoplastic material components according to the invention, advantageously entirely made from the thermoplastic material, the attachment bar can be formed directly by the textile cover itself. This can be achieved in that the thermoplastic material of the textile cover is produced by compressing, advantageously hot compressing. Compressing, in particular, hot compressing, melts or partially melts the thermoplastic fibers and bakes them together. This stiffens the compressed portion of the textile cover to form a bar, so that the compressed section can be used as the attachment bar. Hot compressing can be performed by a hot stamping die. However, it is also possible to transmit energy required for melting or partially melting to the synthetic fibers by vibrations.

This provides a uniform material for the attachment bar and the textile cover. This could also be achieved by sewing on a separate attachment bar onto a textile cover, wherein the attachment bar is made from the same thermoplastic synthetic material as the textile cover itself. Fabrication and assembly of the upholstery piece is simplified significantly, since the separate attachment bar and sewing the separate attachment bar to the textile cover can be omitted entirely.

The invention relates to upholstery pieces for motor vehicles in general and to head rests in particular, where the chassis is formed by a head box that supports the cushion which is covered by the textile cover.

A thickness and thus the strength of the attachment bar produced by thermoplastic compression of the textile cover is a function of the material volume available for compressing. The material volume can be influenced by the thickness of the upholstery fabric material. However, it is also possible to place several textile layers of the textile cover on top of one another in the area to be compressed, so that a larger amount of thermoplastic material is available for producing the attachment bar.

The attachment bar can be stiffened by embossing additional three-dimensional structures, irrespective of a thickness of the attachment bar. These three-dimensional structures can be, in particular, recesses and protrusions generated by the compressing. Thus, a honeycomb or grid structure can be produced which additionally stiffens the attachment bar.

Additionally, the attachment bar can be provided with attachment devices, in particular, with form locking elements, including interlocking devices that are produced by the compressing.

The object is also achieved by a method for producing a textile cover of a motor vehicle upholstery piece, wherein the textile cover includes thermoplastic material portions made from thermoplastic synthetic fibers, the method including hot pressing a section of the textile cover to generate an attachment bar that is stiffer than a non-compressed portion of the textile cover.

The section of the textile cover that is provided for compressing can have multiple layers.

Thus, a thickness of the attachment bar can be defined.

Additionally, a three-dimensional stiffening structure can be generated by compressing the section of the textile cover, in particular, by embossing recesses and protrusions.

These structures additionally stiffen the attachment bar produced by compressing a section of the textile cover.

Attachment elements, in particular form locking elements, in particular interlocking elements, can be produced by compressing the section of the textile cover.

This provides necessary or suitable attachment devices in one method step together with producing the attachment bar.

### BRIEF DESCRIPTION OF THE DRAWINGS

The invention is now described in more detail based on an advantageous embodiment with reference to drawing figures, wherein:

FIG. 1 illustrates a motor vehicle upholstery piece configured as a head rest in an exploded view of a narrow side;

FIG. 2 illustrates the motor vehicle upholstery piece in an assembled view of the narrow side;

FIG. 3 illustrates the attachment bar of the textile cover of FIG. 1 in a first view;

FIG. 4 illustrates the attachment bar of FIG. 3 in a second view; and

FIG. 5 illustrates a sectional view of the upholstery piece according to FIG. 1 parallel to the narrow side.

### DETAILED DESCRIPTION OF THE INVENTION

The drawing figures show an upholstery piece for a motor vehicle provided overall with reference number 10. The upholstery piece 10 is configured as a head rest 10 in an advantageous embodiment.

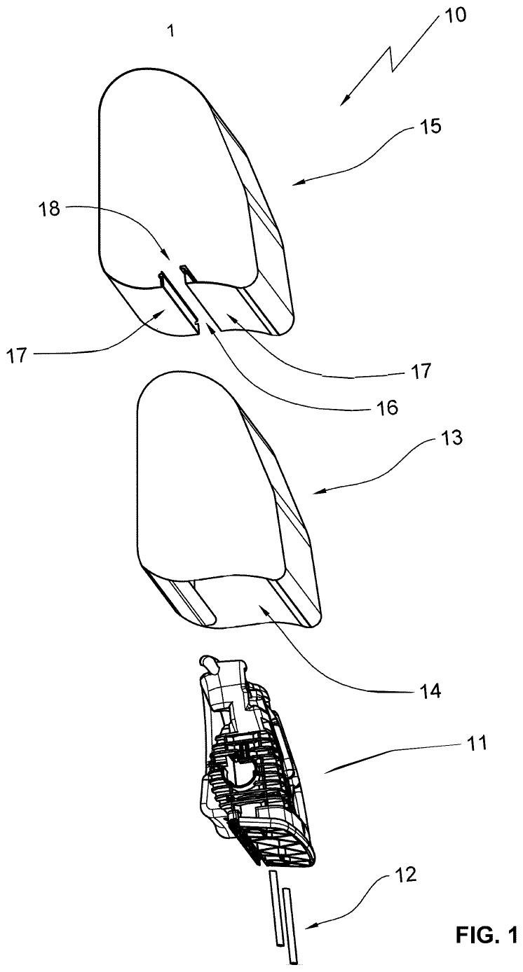

The head rest 10 illustrated in FIG. 1 includes a chassis 11, also designated as head box 11, that is attached to bars 12 configured to be arranged at a back rest of a passenger seat.

Since the chassis 11 or the head box 11 is an injection molded plastic part with relatively little elasticity in the illustrated embodiment, a cushion 13 is placed onto the head box 11 and essentially envelops the head box 11. This provides user comfort, but it also provides protection in case of an accident, since the elastic material of the cushion 13 is shock-absorbent.

The cushion 13 includes an internal receiving cavity 14, configured to receive the headbox 11. When the head rest 10 is assembled, the head box 11 is arranged in the receiving cavity 14.

The upholstery piece 10 includes a textile cover 15 in order to protect the cushion 13 and in order to achieve a pleasant visual appearance. The textile cover 15 includes portions of identical thermoplastic synthetic fibers and is exclusively made from identical thermoplastic synthetic fibers in an advantageous embodiment.

The textile cover 15 includes an opening 16 on its bottom side so that the textile cover can be pulled over the cushion 13. The opening 16 can be closed by one or two closure webs 17 after assembling the portions of the head rest 10. The closure webs 17 respectively include an attachment bar at their free end, wherein the fabrication of the attachment bar is a key feature of the invention. The side of the textile cover 15 oriented towards the viewer is configured transparent in order to show the attachment bars in FIG. 1.

The at least one closure web 17 configured as two closure webs 17 in the advantageous embodiment does not only close the opening of the textile cover 15. The closure webs 17 also cover a lower portion of the cushion 13 oriented towards the rods 12 and a lower portion of the head box 11, so that the headrest 10 is provided with a uniform external appearance by the cover 15.

The attachment bars 18 fix the closure web 17 at the chassis 11 or the head box 11 and thus attach the cover over the cushion and at the chassis, which will be described in more detail infra.

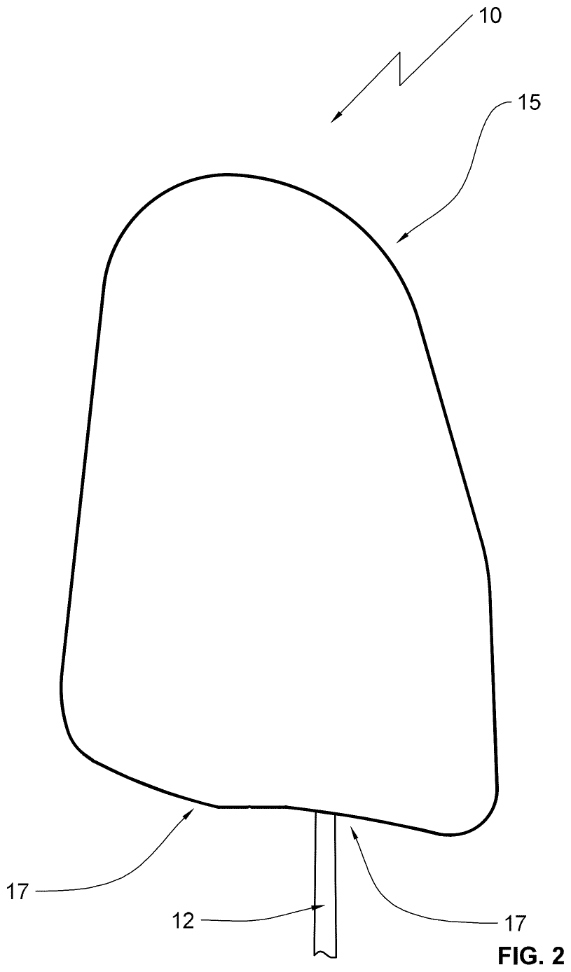

FIG. 2 shows the upholstery piece 10 or the head rest 10 from the exploded view in FIG. 1 in an assembled view. The support rods 12 configured to fix the head rest 10 at a back rest of a passenger seat are inserted into the head box 11. The cushion 13 is placed onto the head box 12 and is enveloped by the textile cover 15, wherein the closure webs 17 of the textile cover 15 close the opening 16 of the textile cover 15 and cover a bottom side of the head box 11.

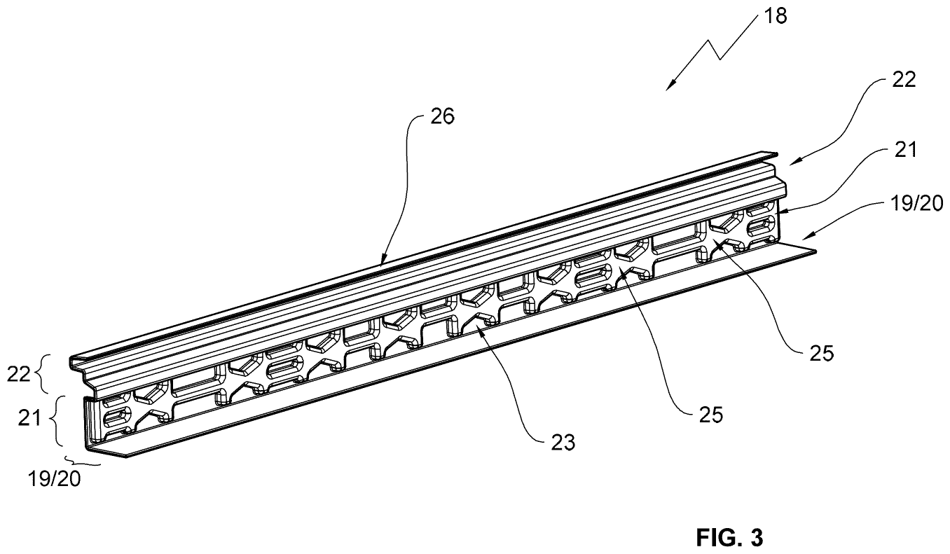

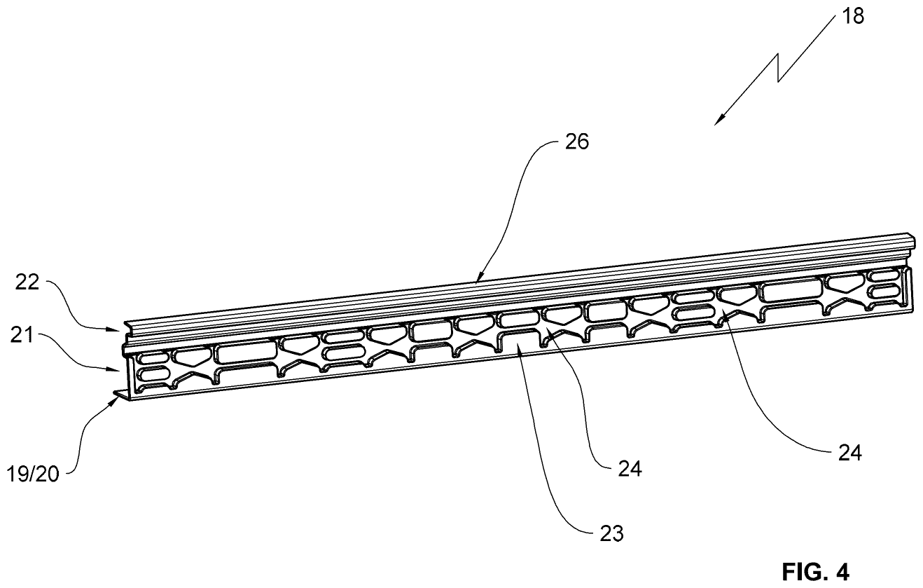

FIG. 3 shows a back side of one of the attachment bars 18 and FIG. 4 shows a front side of one of the attachment bars 18. The designations “back side and front side” thus designate different sides and have no technical significance.

The back side of the attachment bar 18 illustrated in FIG. 3 shows that the attachment bar 18 is divided into three essential sections. On the one hand side, the attachment bar 18 includes an end section 19 that is configured as a rigid bar that is less flexible than the textile material. Alternatively, the end can also be an end flap 20, configured as a textile material that has the same flexibility as the remaining textile cover 15. Arranging the rigid end section 19 or the flexible end flap 20 is performed according to design requirements for the upholstery piece 10.

A stiffening section 21 adjoins the end section 19 or the end flap 20. The stiffening bar is made from a material that is less flexible than the textile material of the cover 15. The stiffening section 21 transitions into an attachment section 22 that is stiffer than the textile material of the textile cover 15. The different sections of the attachment bar 18 are shown in FIG. 4.

A stability, thus stiffness, of the stiffening section 21 can be improved by embossing three-dimensional structures 23 as illustrated in the advantageous embodiment. This three-dimensional structure 23 can be fabricated in a particularly simple manner by embossing recesses 24 as illustrated in FIG. 4 and protrusions 25. Thus, a fabrication method is selected in the embodiment where each recess 24 on a front side of the attachment bar (cf. FIG. 4) causes a protrusion 25 on a back side of the attachment bar 18 (cf. FIG. 3).

The attachment section 22 includes an attachment contour 26. This attachment contour 26 provides mechanical fixing of the attachment bar 18 at the chassis 11 or the head box 11.

The attachment contour 26 can include form locking devices that are used for form locking fixing of the attachment bar at the head box 11. This includes, in particular, an interlocking, so that the form locking devices can be configured as interlocking elements.

The attachment contour 26 can also be used to fix the attachment bar 18 at the chassis 11 or the head box 11 in a friction locking or form locking manner. In this case, the contour can be used to provide reset elasticity that is required for sufficient friction locking or form locking. These contours can provide spring element structures through reset elastic bending folds.

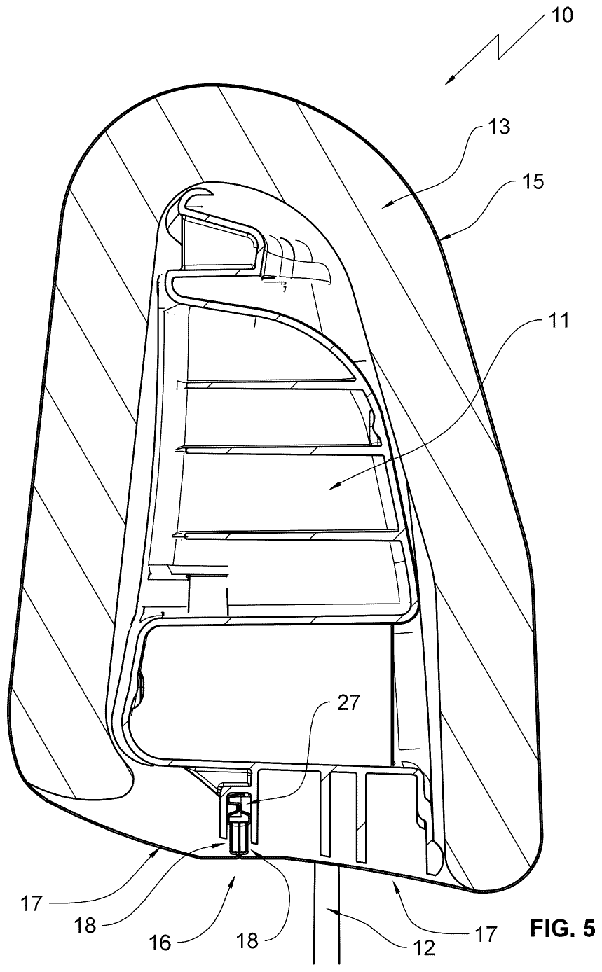

FIG. 5 shows a longitudinal sectional view through the head rest 10 assembled according to FIG. 2. This shows how the head box 11 is received by the cushion 13 and how the cushion 13 is in turn enveloped by the textile cover 15. The closure webs 17 and the attachment bars 18 adjoining thereto form part of the textile cover 15. The attachment bars 18 are placed into a fixing groove 27, providing friction locking or form locking and thus close the opening 16 of the textile cover 15. By the same token, the bottom side of the head box 11, which would otherwise be visible through the opening 16, is being covered. Thus, the textile cover 15 provides a pleasant uniform visual appearance for the head rest 10.

According to the invention, the textile cover 15 forms the at least one attachment bar 18 that is configured in the embodiment as two attachment bars 18.

In an advantageous embodiment, the textile cover or the textile material that forms the textile cover 15 includes thermoplastic synthetic fibers and is fabricated in a particularly advantageous embodiment exclusively from one synthetic fiber made from exactly one thermoplastic synthetic material.

The piece of textile material from which the textile cover 15 is fabricated is cut out initially. This provides one or plural pieces of textile material which are sewn together to form the textile cover 15. Before producing the actual textile cover, at least one cut blank is hot compressed in areas where the attachment bar 18 or the attachment bars 18 shall be arranged at the textile cover 15. Thus, the thermoplastic synthetic fibers of the textile material are melted and cross linked, and flexibility of the textile material in these areas is degraded. Stiff, less flexible sections are created instead.

Thermal compressing is performed by a predetermined tool that represents a negative contour of the attachment bar 18. The textile blank is removed from the tool after hot pressing and has obtained the attachment bar 18 through the forming controur.

Hot pressing enables producing the three-dimensional structures 23 of the stiffening section 21 and forming the attachment section 22.

Forming a stiff end section 19 or having the textile blank transition into the attachment bar 18 through the non-compressed end flap 20 depends on whether the end section 19 is helpful for inserting the attachment bar 18 into the fixing groove 27.

The invention stipulates fabricating the attachment bar 18 directly from the textile material, so that the attachment bar 18 is usable for directly mechanically fixing the textile cover 15 at the chassis 11. This provides the cover from one single material which can be recycled without any separation or sorting effort. Additionally, storing and attaching separate attachment bars can be omitted, in particular sewing them to the textile cover 15.

Several textile layers can be placed on top of each other in the textile section to be compressed in order to fabricate a sufficiently thick and strong attachment bar 18, so that a sufficient amount of material is provided for forming and stiffening pressing of the textile material.

### REFERENCE NUMERALS AND DESIGNATIONS

10 upholstery piece/head rest
11 chassis/head box
12 support bar
13 cushion
14 receiving cavity
15 textile cover
16 opening
17 closure web
18 attachment bar
19 end section
20 end flap
21 stiffening section
22 attachment section
23 structure
24 recess
25 protrusion
26 attachment contour
27 fixing groove

What is claimed is:

1. An upholstery piece of a motor vehicle, the upholstery piece comprising:
a chassis;
a cushion arranged at the chassis;
a textile cover at least partially covering and/or enveloping the cushion and including an attachment contour; and
an attachment bar arranged at the textile cover and fixable at the chassis by the attachment contour,
wherein the textile cover includes a thermoplastic material made from thermoplastic synthetic fibers, and
wherein the thermoplastic material of the textile cover is compressed to form the attachment bar.

2. The upholstery piece according to claim 1,
wherein the upholstery piece is configured as a head rest, and
wherein the chassis is formed by a head box that supports the cushion covered by the textile cover.

3. The upholstery piece according to claim 1, wherein plural textile layers of the textile cover are placed over one another in a portion that is compressed to form the attachment bar.

4. The upholstery piece according to claim 1, wherein the attachment bar is mechanically stiffened by embossed structures configured as recesses and/or protrusions.

5. The upholstery piece according to claim 1, wherein the attachment bar includes attachment devices configured as form locking elements or interlocking elements formed by pressing.

6. A method for producing a textile cover of a motor vehicle upholstery piece, wherein the textile cover includes thermoplastic material portions made from thermoplastic synthetic fibers, the method comprising:
hot pressing a section of the textile cover to generate an attachment bar that is stiffer than a non-compressed portion of the textile cover.

7. The method according to claim 6, wherein the textile cover is configured in multiple layers in the section that is hot compressed.

8. The method according to claim 6, wherein a three-dimensional stiffening structure is produced when compressing the section of the textile cover by embossing recesses and protrusions.

9. The method according to claim 6, wherein compressing the section of the textile cover generates attachment devices or form locking devices or interlocking elements.
